(19) United States
(12) Patent Application Publication
(10) Pub. No.: US 2024/0199878 A1
(43) Pub. Date: Jun. 20, 2024

(54) RESIN COMPOSITION, FORMED ARTICLE AND FILM

(71) Applicant: KANEKA CORPORATION, Osaka (JP)

(72) Inventors: Kohei Ogawa, Osaka (JP); Jun Kamite, Osaka (JP)

(73) Assignee: KANEKA CORPORATION, Osaka (JP)

(21) Appl. No.: 18/437,517

(22) Filed: Feb. 9, 2024

Related U.S. Application Data
(63) Continuation of application No. PCT/JP22/31388, filed on Aug. 19, 2022.

(30) Foreign Application Priority Data
Aug. 24, 2021 (JP) 2021-136477

(51) Int. Cl. C08L 79/08; C08J 5/18; C08L 33/04

(52) U.S. Cl. CPC C08L 79/08; C08J 5/18; C08L 33/04; C08J 2333/04; C08J 2379/08; C08J 2433/04; C08J 2479/08

(57) ABSTRACT

A resin composition includes a polyimide and an acryl-based resin. The polyimide includes alicyclic tetracarboxylic dianhydride such as 1,2,3,4-cyclobutanetetracarboxylic dianhydride as a tetracarboxylic dianhydride component, and a diamine having a perfluoroalkyl group such as 2,2′-bis(trifluoromethyl)benzidine as a diamine component. An amount of the alicyclic tetracarboxylic dianhydride based on an amount of all tetracarboxylic dianhydride components in the polyimide is 1 to 80 mol %.

### TECHNICAL FIELD

One or more embodiments of the present invention relate to a resin composition, and a formed article such as a film.

### BACKGROUND

Electronics devices such as display devices such as liquid crystal displays, organic EL displays and electronic papers, solar cells, and touch panels are required to be thin, lightweight and flexible. Glass materials that are used for these devices are replaced by film materials to make the devices flexible, thin and lightweight. As a replacement for glass, a transparent polyimide film has been developed and used for substrates for displays, cover films and the like.

A normal polyimide film is obtained by applying a polyamic acid solution, which is a polyimide precursor, onto a support in the form of a film, and subjecting the film to high-temperature treatment to remove a solvent and perform thermal imidization. However, the heating temperature for thermal imidization is high (e.g. 300° C. or higher), and coloring (increased yellowness) by heating is likely to occur, so that thermally-imidized polyimide is not suitable for products required to have high transparency, such as cover films for displays.

As a method for manufacturing a polyimide film having high transparency, a method using an organic solvent-soluble polyimide, which does not require high temperature imidization after being formed into a film, has been proposed. For example, Patent Document 1 indicates that a polyimide containing a bis-trimellitic dianhydride ester as a tetracarboxylic dianhydride component is soluble in a low-boiling-point solvent such as methylene chloride and excellent in transparency and mechanical strength.

### PATENT DOCUMENT

Patent Document 1: International Publication No. WO 2020/004236

In a polyimide, introduction of a rigid structure improves mechanical strength, but causes a decrease in solubility in an organic solvent and transparency, and it is not easy for a conventional transparent polyimide resin to have both transparency and high mechanical strength while maintaining solubility. In view of the above, one or more embodiments of the present invention provide a formed article such as a film which has high transparency and sufficient mechanical strength, and a resin composition which is used for production of the transparent film.

### SUMMARY

The present inventors have found that a polyimide having a specific chemical structure and an acryl-based resin are compatible with each other, and a film having high transparency can be produced from a resin composition of blending the polyimide and the ester-based resin without impairing the excellent mechanical strength of the polyimide, thereby solving the above.

An aspect of one or more embodiments of the present invention relates to a film and a resin composition each containing a polyimide resin and an acryl-based resin. The resin composition may contain a polyimide resin and an acryl-based resin at a weight ratio of 98:2 to 2:98.

The polyimide contains alicyclic tetracarboxylic dianhydride as a tetracarboxylic dianhydride component. As the alicyclic tetracarboxylic dianhydride, 1,2,3,4-cyclobutanetetracarboxylic dianhydride, 1,2,3,4-cyclopentanetetracarboxylic dianhydride, 1,2,4,5-cyclohexanetetracarboxylic dianhydride, 1,1′-bicyclohexane-3,3′,4,4′-tetracarboxylic-3,4:3′,4′-dianhydride, and the like are preferable. Among them, 1,2,3,4-cyclobutanetetracarboxylic dianhydride is particularly preferable.

The polyimide may include at least one selected from the group consisting of fluorine-containing aromatic tetracarboxylic dianhydride, bis(trimellitic anhydride) ester, and diphthalic anhydride having an ether bond in addition to alicyclic tetracarboxylic dianhydride, as tetracarboxylic dianhydride components.

The amount of aliphatic tetracarboxylic dianhydride may be 1 to 80 mol % based on the amount of all tetracarboxylic dianhydride components in the polyimide. The total content of alicyclic tetracarboxylic dianhydride, fluorine-containing aromatic tetracarboxylic dianhydride, bis(trimellitic anhydride)ester and diphthalic anhydride having an ether bond may be 50 mol % or more based on the amount of all tetracarboxylic dianhydrides in the polyimide.

The polyimide contains a diamine having a perfluoroalkyl group as a diamine component. The diamine having a perfluoroalkyl group may be a perfluoroalkyl-substituted benzidine such as 2,2′-bis(trifluoromethyl)benzidine. The amount of the diamine having a perfluoroalkyl group may be 50 mol % or more based on the amount of all diamine components in the polyimide.

The film according to one or more embodiments of the present invention has a thickness of 5 μm or more and 300 μm or less, a haze of 10% or less, a yellowness index of 2.0 or less, a tensile elastic modulus of 3.3 Gpa or more, and a pencil hardness equal to or greater than F.

Since a polyimide resin and an acryl-based resin contained in a resin composition are compatible with each other, a transparent film having a small haze is obtained. In addition, since the polyimide resin and the acryl-based resin are compatible with each other, coloring can be suppressed without significantly deteriorating the excellent mechanical strength of the polyimide, and a transparent film suitable for cover films of displays, etc. can be produced.

### BRIEF DESCRIPTION OF THE DRAWINGS

FIGS. 1A-1D show transmission electron microscope images of planes and cross-sections of films of an example and a comparative example.

### DETAILED DESCRIPTION OF THE EMBODIMENTS

### Resin Composition

One or more embodiments of the present invention are a compatible resin composition containing a polyimide resin and an acryl-based resin.

### Polyimide

The polyimide is obtained by cyclodehydration of a polyamic acid obtained by addition polymerization of a tetracarboxylic dianhydride (hereinafter, sometimes referred to as an “acid dianhydride”) with a diamine. That is, the polyimide is a polycondensation product of tetracarboxylic dianhydride and a diamine, and has an acid dianhydride-derived structure (acid dianhydride component) and a diamine-derived structure (diamine component).

The polyimide for use in one or more embodiments may be soluble in an organic solvent, and the polyimide can be dissolved in N,N-dimethylformamide (DMF) at a concentration of 1 wt % or more. The polyimide may be soluble in a non-amide-based solvent as well as in an amide-based solvent such as DMF.

### Acid Dianhydride

The polyimide for use in one or more embodiments contains alicyclic tetracarboxylic dianhydride as an acid dianhydride component. When the acid dianhydride component has an alicyclic structure, compatibility between a polyimide resin and an acryl-based resin tends to be improved. The alicyclic tetracarboxylic dianhydride is only required to have at least one alicyclic structure, and may have both an alicyclic ring and an aromatic ring in one molecule. The alicyclic ring may be polycyclic, or may have a spiro structure.

Examples of the alicyclic tetracarboxylic dianhydride include 1,2,3,4-cyclobutanetetracarboxylic dianhydride, 1,2,3,4-cyclopentanetetracarboxylic dianhydride, 1,3-dimethylcyclobutane-1,2,3,4-tetracarboxylic dianhydride, 1,2,3,4-tetramethyl-1,2,3,4-cyclobutanetetracarboxylic dianhydride, 1,2,4,5-cyclohexanetetracarboxylic dianhydride, 1,2,3,4-butanetetracarboxylic dianhydride, meso-butane-1,2,3,4-tetracarboxylic dianhydride, 1,1′-bicyclohexane-3,3′,4,4′ tetracarboxylic-3,4:3′,4′-dianhydride, norbornane-2-spiro-α-cyclopentanone-α′-spiro-2″-norbornane-5,5″,6,6″-tetracarboxylic dianhydride, 2,2′-binorbornane-5,5′,6,6′ tetracarboxylic dianhydride, 3-(carboxymethyl)-1,2,4-cyclopentanetricarboxylic 1,4:2,3-dianhydride, bicyclo[2.2.2]octa-7-ene-2,3,5,6-tetracarboxylic dianhydride, 4-(2,5-dioxotetrahydrofuran-3-yl)-1,2,3,4-tetrahydronaphthalene-1,2-dicarboxylic anhydride, cyclohexane-1,4-diylbis(methylene)bis(1,3-dioxo-1,3-dihydroisobenzofuran-5-carboxylate), 5-(2,5-dioxotetrahydrofuryl)-3-methyl-3-cyclohexene-1,2-dicarboxylic anhydride, 5,5′-[cyclohexylidenebis(4,1-phenyleneoxy)]bis-1,3-isobenzofurandione, 5-isobenzofurancarboxylic acid, 1,3-dihydro-1,3-dioxo-,5,5′-[1,4-cyclohexanediylbis(methylene)]ester, bicyclo[2.2.1]heptane-2,3,5,6-tetracarboxylic dianhydride, bicyclo[2.2.2]octane-2,3,5,6-tetracarboxylic dianhydride, 3,5,6-tricarboxynorbornane-2-acetic 2,3:5,6-dianhydride, decahydro-1,4,5,8-dimethanonaphthalene-2,3,6,7-tetracarboxylic dianhydride, tricyclo[6.4.0.0 (2,7)]dodecane-1,8:2,7-tetracarboxylic dianhydride, octahydro-1H,3H,8H,10H-biphenyleno[4a,4b-c:8a,8b-c′]difuran-1,3,8,10-tetrone, ethylene glycolbis(hydrogenated trimellitic anhydride)ester, and decahydro[2]benzopyrano[6,5,4,-def] [2]benzopyrano-1,3,6,8-tetrone.

Among the alicyclic tetracarboxylic dianhydrides, 1,2,3,4-cyclobutanetetracarboxylic dianhydride (CBDA), 1,2,3,4-cyclopentanetetracarboxylic dianhydride (CPDA), 1,2,4,5-cyclohexanetetracarboxylic dianhydride (H-PMDA), or 1,1′-bicyclohexane-3,3′,4,4′-tetracarboxylic-3,4:3′,4′-dianhydride (H-BPDA) is preferable from the viewpoint of the transparency and mechanical strength of the polyimide. In particular, tetracarboxylic anhydride in which two anhydride groups are bonded to one alicyclic ring is preferable, 1,2,3,4-cyclobutanetetracarboxylic dianhydride is particularly preferable, from the viewpoint of mechanical strength.

From the viewpoint of improving compatibility between the polyimide resin and the acryl-based resin, the content of alicyclic tetracarboxylic dianhydride based on 100 mol % of all acid dianhydride components may be 1 mol % or more, 3 mol % or more, 5 mol % or more, 6 mol % or more, 7 mol % or more, 8 mol % or more, 9 mol % or more, 10 mol % or more, 12 mol % or more, or 15 mol % or more. The amount of the alicyclic tetracarboxylic dianhydride required for imparting compatibility with the acryl-based resin may vary depending on, for example, the types of the acryl-based resin and the alicyclic tetracarboxylic dianhydride. For example, when the alicyclic tetracarboxylic dianhydride is 1,2,3,4-cyclobutanetetracarboxylic dianhydride (CBDA), the content of CBDA based on 100 mol % of all acid dianhydride components may be 6 mol % or more, 8 mol % or more, or 10 mol % or more.

From the viewpoint of securing the solubility of the polyimide resin in an organic solvent, the content of the alicyclic tetracarboxylic dianhydride based on 100 mol % of all acid dianhydride components may be 80 mol % or less, 78 mol % or less, 76 mol % or less, 74 mol % or less, 72 mol % or less, 70 mol % or less, 65 mol % or less, 60 mol % or less, 55 mol % or less, or 50 mol % or less. In order for the polyimide resin to be compatible with the acryl-based resin even in a low-boiling-point non-amide-based solvent (for example, a halogen-based solvent such as methylene chloride), the content of the alicyclic tetracarboxylic dianhydride may be 45 mol % or less, 40 mol % or less, or 35 mol % or less.

In order for the polyimide resin and the acryl-based resin to be compatible with each other in an organic solvent, the polyimide may contain fluorine-containing aromatic tetracarboxylic dianhydride, bis(trimellitic anhydride)ester or/and diphthalic anhydride having an ether bond, in addition to alicyclic tetracarboxylic dianhydride, as acid dianhydride components.

Examples of the fluorine-containing aromatic tetracarboxylic dianhydride include 2,2-bis(3,4-dicarboxyphenyl)-1,1,1,3,3,3-hexafluoropropanoic dianhydride, and 2,2-bis{4-[4-(1,2-dicarboxyphenyl)phenoxy]phenyl}-1,1,1,3,3,3-hexafluoropropane dianhydride. Of these, 2,2-bis(3,4-dicarboxyphenyl)-1,1,1,3,3,3-hexafluoropropane dianhydride (6FDA) is particularly preferable.

The bis(trimellitic anhydride)ester is represented by the following general formula (1).

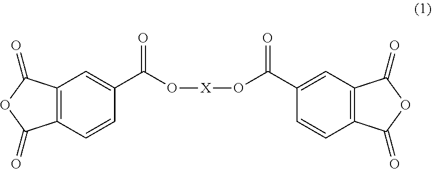

X in general formula (1) is an arbitrary divalent organic group, and a carboxy group and a carbon atom of X are bonded to each other at both ends of X. The carbon atom bonded to the carboxy group may form a ring structure. Specific examples of the divalent organic group X include the following (A) to (K).

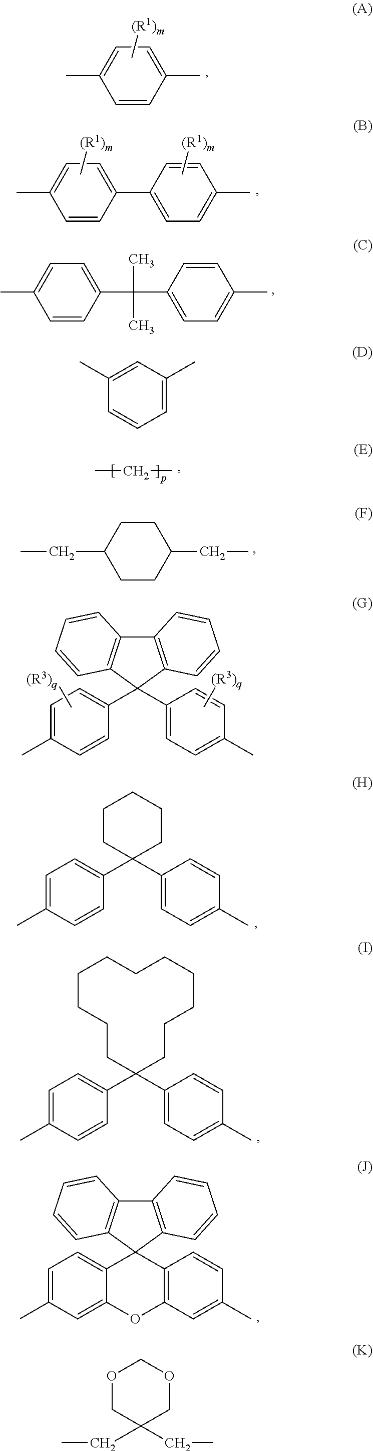

R¹ in formula (A) is a fluorine atom, an alkyl group having 1 to 20 carbon atoms, or a fluoroalkyl group having 1 to 20 carbon atoms, and m is an integer of 1 to 4. The group of formula (A) is a group obtained by removing two hydroxy groups from a hydroquinone derivative having a substituent on a benzene ring. Examples of the hydroquinone having a substituent on a benzene ring include tert-butylhydroquinone, 2,5-di-tert-butylhydroquinone and 2,5-di-tert-amylhydroquinone.

In formula (B), R² is a fluorine atom, an alkyl group having 1 to 20 carbon atoms, or a fluoroalkyl group having 1 to 20 carbon atoms, and n is an integer of 0 to 4. The group of formula (B) is a group obtained by removing two hydroxy groups from biphenol optionally having a substituent on a benzene ring. Examples of the biphenol derivative having a substituent on a benzene ring include 2,2′-dimethylbiphenyl-4,4′-diol, 3,3′-dimethylbiphenyl-4,4′-diol, 3,3′,5,5′-tetramethylbiphenyl-4,4′-diol and 2,2′,3,3′,5,5′-hexamethylbiphenyl-4,4′-diol.

The group of formula (C) is a group obtained by removing two hydroxy groups from 4,4′-isopropylidenediphenol (bisphenol A). The group of formula (D) is a group obtained by removing two hydroxy groups from resorcinol.

In formula (E), p is an integer of 1 to 10. The group of formula (E) is a group obtained by removing two hydroxy groups from a linear diol having 1 to 10 carbon atoms. Examples of the linear diol having 1 to 10 carbon atoms include ethylene glycol, and 1,4-butanediol.

The group of formula (F) is a group obtained by removing two hydroxy groups from 1,4-cyclohexanedimethanol.

In formula (G), R³ is a hydrogen atom, a fluorine atom, an alkyl group having 1 to 20 carbon atoms, or a fluoroalkyl group having 1 to 20 carbon atoms, and q is an integer of 0 to 4. The group of formula (G) is a group obtained by removing two hydroxy groups from biphenol fluorene optionally having a substituent on a benzene ring having a phenolic hydroxy group. Examples of the bisphenol fluorene derivative having a substituent on a benzene ring having a phenolic hydroxy group include biscresol fluorene.

The bis(trimellitic anhydride)ester may be an aromatic ester. Among the above groups (A) to (K), groups (A), (B), (C), (D), (G), (H) and (I) may be as X. Among them, the groups (A) to (D) are preferable, and the group (B) having a biphenyl backbone is particularly preferable. When X is a group of general formula (B), X may be 2,2′,3,3′,5,5′-hexamethylbiphenyl-4,4′-diyl of the following formula (B1) from the viewpoint of the solubility of the polyimide resin.

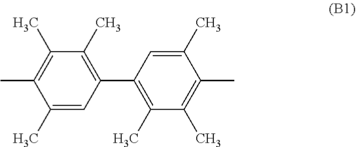

The acid dianhydride in which X is a group of formula (B1) in general formula (1) is bis(1,3-dioxo-1,3-dihydroisobenzofuran-5-carboxylic acid)-2,2′,3,3′,5,5′-hexamethylbiphenyl-4,4′ diyl (abbreviation: TAHMBP) of the following formula (3).

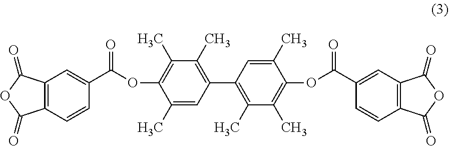

Examples of the diphthalic anhydride having an ether bond include 3,4′-oxydiphthalic anhydride, 4,4′-oxydiphthalic anhydride, and 4,4′-(4,4′-isopropylidenediphenoxy)diphthalic anhydride. From the viewpoint of the solubility of the polyimide resin and compatibility with the acryl-based resin, 4′-(4,4-isopropylidenediphenoxy)diphthalic anhydride (BPADA) is particularly preferable.

From the viewpoint that the polyimide resin is soluble in an organic solvent, the total content of the fluorine-containing aromatic tetracarboxylic dianhydride, the bis(trimellitic anhydride)ester and the diphthalic anhydride having an ether bond may be 15 mol % or more, 20 mol % or more, 25 mol % or more, 30 mol % or more, 35 mol % or more, 40 mol % or more, 45 mol % or more, or 50 mol % or more, based on 100 mol % of all acid dianhydride components. The total content of the fluorine-containing aromatic tetracarboxylic dianhydride, the bis(trimellitic anhydride)ester and the diphthalic anhydride having an ether bond may be 99 mol % or less, 95 mol % or less, 90 mol % or less, 85 mol % or less, 80 mol % or less, 75 mol % or less, or 70 mol % or less, based on 100 mol % of all acid dianhydride components.

From the viewpoint of obtaining a polyimide resin having both solubility in an organic solvent and compatibility with an acryl-based resin, the total content of the alicyclic tetracarboxylic dianhydride, the fluorine-containing aromatic tetracarboxylic dianhydride, the bis(trimellitic anhydride)ester and the diphthalic anhydride having an ether bond may be 50 mol % or more, 60 mol % or more, 65 mol % or more, 70 mol % or more, 75 mol % or more, 80 mol % or more, 85 mol % or more, 90 mol % or more, or 95 mol % or more, based on 100 mol % of all acid dianhydride components.

As described above, 6FDA is particularly preferable as the fluorine-containing aromatic tetracarboxylic dianhydride, TAHMBP is particularly preferable as the bis(trimellitic anhydride)ester, and BPADA is particularly preferable as the diphthalic anhydride having an ether bond. CBDA is particularly preferable as the alicyclic tetracarboxylic dianhydride.

Among fluorine-containing aromatic tetracarboxylic dianhydride, bis(trimellitic anhydride)ester and diphthalic anhydride having an ether bond, fluorine-containing aromatic tetracarboxylic dianhydride and bis(trimellitic anhydride)ester are preferable from the viewpoint of mechanical strength. Among them, 6FDA and TAHMBP are particularly preferable.

For the polyimide resin to have high solubility in an organic solvent, high compatibility with the acryl-based resin, and excellent mechanical strength, the total content of the fluorine-containing aromatic tetracarboxylic dianhydride and the bis(trimellitic anhydride)ester may be 15 to 99 mol %, 20 to 97 mol %, 25 to 95 mol %, 30 to 90 mol %, 35 to 85 mol %, 40 to 80 mol %, 45 to 75 mol %, or 50 to 70 mol %, based on 100 mol % of all acid dianhydride components. In particular, the total content of 6FDA and TAHMBP may be in the above-described range.

For the polyimide resin to have high solubility in an organic solvent, high compatibility with the acryl-based resin, and excellent mechanical strength, the total content of the alicyclic tetracarboxylic dianhydride, the fluorine-containing aromatic tetracarboxylic dianhydride and the bis(trimellitic anhydride)ester may be 50 mol % or more, 60 mol % or more, 65 mol % or more, 70 mol % or more, 75 mol % or more, 80 mol % or more, 85 mol % or more, 90 mol % or more, or 95 mol % or more, based on 100 mol % of all acid dianhydride components.

The polyimide may contain acid dianhydride other than alicyclic tetracarboxylic anhydride, fluorine-containing aromatic tetracarboxylic dianhydride, bis(trimellitic anhydride) ester and diphthalic anhydride having an ether bond in addition to alicyclic tetracarboxylic dianhydride, as a dianhydride component. Examples of acid dianhydrides other than those described above include ethylenetetracarboxylic dianhydride, butanetetracarboxylic dianhydride, 3,3′,4,4′-benzophenonetetracarboxylic anhydride, 2,2′,3,3′-benzophenonetetracarboxylic anhydride, 2,2′,3,3′-biphenyltetracarboxylic dianhydride, pyromellitic dianhydride, 3,3′,4,4′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 9,9-bis(3,4-dicarboxyphenyl)fluorene dianhydride, 1,3-bis[(3,4-dicarboxy)benzoyl]benzene dianhydride, 1,4-bis[(3,4-dicarboxy)benzoyl]benzene dianhydride, 2,2-bis{4-[4-(1,2-dicarboxy)phenoxy]phenyl}propane dianhydride, 2,2-bis{4[4-(3,4-dicarboxy)phenoxy]phenyl}propane dianhydride, 2,2-bis{4-[3-(1,2-dicarboxy)phenoxy]phenyl}propane dianhydride, bis{4-[4-(1,2-dicarboxy)phenoxy]phenyl}ketone dianhydride, bis{4-[3-(1,2-dicarboxy)phenoxy]phenyl}ketone dianhydride, 4,4′-bis[4-(1,2-dicarboxy)phenoxy]biphenyl dianhydride, 4,4′-bis[3-(1,2-dicarboxy)phenoxy]biphenyl dianhydride, bis{4-[4-(1,2-dicarboxy)phenoxy]phenyl}ketone dianhydride, bis{4-[3-(1,2-dicarboxy)phenoxy]phenyl}ketone dianhydride, bis{4-[4-(1,2-dicarboxy)phenoxy]phenyl}sulfone dianhydride, bis{4-[3-(1,2-dicarboxy)phenoxy]phenyl}sulfone dianhydride, bis{4-[4-(1,2-dicarboxy)phenoxy]phenyl}sulfide dianhydride, bis{4-[3-(1,2-dicarboxy)phenoxy]phenyl}sulfide dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, 1,2,7,8-phenyltetracarboxylic dianhydride, and bis(1,3-dihydro-1,3-dioxo-5-isobenzofurancarboxylic acid)-1,4-phenylene ester.

### Diamine

The diamine component of the polyimide for use in one or more embodiments is not particularly limited. From the viewpoint of solubility, the diamine of the polyimide resin may have at least one selected from the group consisting of a fluorine group, a perfluoroalkyl group, a sulfone group, a fluorene structure and an alicyclic structure. In particular, from the viewpoint of securing both solubility and transparency of the polyimide resin, the polyimide may contain a diamine having a perfluoroalkyl group as a diamine component. The perfluoroalkyl group may be a trifluoromethyl group.

Examples of the diamine having a perfluoroalkyl group include perfluoroalkyl-substituted benzidines. Examples of perfluoroalkyl-substituted benzidine include 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoromethyl)benzidine, 2,2′-bis(trifluoromethyl)benzidine, 3,3′-bis(trifluoromethyl)benzidine, 2,3′-bis(trifluoromethyl)benzidine, 2,2′,3-bis(trifluoromethyl)benzidine, 2,3,3′-tris(trifluoromethyl)benzidine, 2,2′,5-tris(trifluoromethyl)benzidine, 2,2′,6-tris(trifluoromethyl)benzidine, 2,3′,5-tris(trifluoromethyl)benzidine, 2,3′,6,-tris(trifluoromethyl) benzidine, 2,2′,3,3′-tetrakis (trifluoromethyl)benzidine, 2,2′,5,5′-tetrakis(trifluoromethyl)benzidine, and 2,2′,6,6′-tetrakis(trifluoromethyl)benzidine.

Other examples of the diamine having a perfluoroalkyl group include phenylenediamines having a perfluoroalkyl substitution, such as 1,4-diamino-2-(trifluoromethyl)bensen, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene, and 1,4-diamino-2,3,5,6-tetrakis(trifluoromethyl)benzene; 2,2-bis[4-(4-aminophenoxy)phenyl]-1,1,1,3,3,3-hexafluoropropane, and 2,2-bis(4-aminophenyl) hexafluoropropane.

From the viewpoint of mechanical strength, perfluoroalkyl-substituted benzidine is preferable. In particular, from the viewpoint of the solubility of the polyimide resin in an organic solvent and the compatibility of the polyimide resin with the acryl-based resin, perfluoroalkyl-substituted benzidines having a perfluoroalkyl group at the 2-position of biphenyl are preferable, and 2,2′-bis(trifluoromethyl)benzidine (hereinafter, referred to as “TFMB”) is particularly preferable. When a trifluoromethyl group is present at each of 2- and 2′-positions of biphenyl, the x-electron density decreases due to the electron-attracting property of the trifluoromethyl group, and a bond between two benzene rings of biphenyl is twisted by steric hindrance of the trifluoromethyl group, leading to a decrease in planarity of the x-conjugate. Therefore, the absorption edge wavelength shifts to a short wave, so that coloring of the polyimide can be suppressed.

The content of the diamine having a perfluoroalkyl group based on 100 mol % of all diamine components may be 50 mol % or more, 60 mol % or more, 70 mol % or more, 80 mol % or more, 85 mol % or more, or 90 mol % or more. In particular, the amount of the perfluoroalkyl-substituted benzidine may be in the above-described range. A large content of the diamine having a perfluoroalkyl group tends to lead to suppression of coloring of the film, and enhancement of mechanical strength in terms of pencil hardness, elastic modulus and the like.

The polyimide may contain a diamine free of a perfluoroalkyl group as a diamine component. Examples of the diamine free of a perfluoroalkyl group include p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenylsulfone, 3,4′-diaminodiphenylsulfone, 4,4′-diaminodiphenylsulfone, 9,9-bis(4-aminophenyl)fluorene, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl) benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, 4,4′-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-phenoxybenzophenone, 6,6′-bis(3-aminophenoxy)-3,3,3′,3′-tetramethyl-1,1′-spirobiindan, 6,6′-bis(4-aminophenoxy)-3,3,3′,3′-tetramethyl-1,1′-spirobiindan, 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminoprotoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, diethylene glycol bis(3-aminopropyl)ether, triethylene glycol bis(3-aminopropyl)ether, ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,2-diaminocyclohexane, 1,3-diaminocyclohexane, 1,4-diaminocyclohexane, trans-1,4-diaminocyclohexane, 1,2-di(2-aminoethyl)cyclohexane, 1,3-di(2-aminoethyl)cyclohexane, 1,4-di(2-aminoethyl)cyclohexane, bis(4-aminocyclohexyl)methane, 2,6-bis(aminomethyl)bicyclo[2.2.1]heptane, 2,5-bis(aminomethyl)bicyclo[2.2.1]heptane, 1,4-diamino-2-fluorobenzene, 1,4-diamino-2,3-difluorobenzene, 1,4-diamino-2,5-difluorobenzene, 1,4-diamino-2,6-difluorobenzene, 1,4-diamino-2,3,5-trifluorobenzene, 1,4-diamino-2,3,5,6-tetrafluorobenzene, 2,2′-dimethylbenzidine, 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′,6-trifluorobenzidine, 2,3′,5-trifluorobenzidine, 2,3′,6-trifluorobenzidine, 2,2′,3,3′-tetrafluorobenzidine, 2,2′,5,5′-tetrafluorobenzidine, 2,2′,6,6′-tetrafluorobenzidine, 2,2′,3,3′,6,6′-hexafluorobenzidine, and 2,2′,3,3′,5,5′,6,6′-octafluorobenzidine.

For example, by using diaminodiphenylsulfone in addition to the diamine having a perfluoroalkyl group, as diamines, the solvent-solubility and the transparency of the polyimide resin may be improved. Among the diaminodiphenyl sulfones, 3,3′-diaminodiphenyl sulfone(3,3′-DDS) and 4,4′-diaminodiphenyl sulfone(4,4′-DDS) are preferable. Both 3,3′-DDS and 4,4′-DDS may be used in combination.

The content of diaminodiphenylsulfone based on 100 mol % of all diamines may be 1 to 40 mol %, 3 to 30 mol %, or 5 to 25 mol %.

### Preparation of Polyimide

A polyamic acid as a polyimide precursor is obtained by a reaction between an acid dianhydride and a diamine, and a polyimide is obtained by cyclodehydration (imidization) of the polyamic acid. As described above, adjustment of the composition of the polyimide, i.e., the types and ratios of the acid dianhydride and the diamine, allows the polyimide to have transparency and solubility in an organic solvent and exhibit compatibility with an acryl-based resin.

The method for preparing a polyamic acid solution is not particularly limited, and any known method can be applied. For example, the acid dianhydride and the diamine are dissolved in an organic solvent in substantially equimolar amounts (molar ratio=95:100 to 105:100), and the solution is stirred to obtain a polyamic acid solution. The concentration of the polyamic acid solution may be typically 5 to 35 wt %, or 10 to 30 wt %. When the concentration is in this range, the polyamic acid obtained by polymerization has an appropriate molecular weight, and the polyamic acid solution has an appropriate viscosity.

In the polymerization of the polyamic acid, an acid dianhydride may be added to a diamine for suppressing ring opening of the acid dianhydride. When a multiple kinds of diamine and a multiple kinds of acid dianhydride are added, they may be added at one time, or may be added in a plurality of additions. By adjusting the order of adding the monomers, various physical properties of the polyimide can be controlled.

The organic solvent used for polymerization of the polyamic acid is not particularly limited as long as it does not react with a diamine and an acid dianhydride and can dissolve the polyamic acid. Examples of the organic solvent include urea-based solvents such as methylurea and N,N-dimethylethylurea; sulfoxide or sulfone-based solvents such as dimethyl sulfoxide, diphenylsulfone and tetramethylsulfone; amide-based solvents such as N,N-dimethyacetamide (DMAc), N,N-dimethylformamide (DMF), N,N′-diethylacetamide, N-methyl-2-pyrrolidone (NMP), γ-butyrolactone and hexamethylphosphoric triamide; alkyl halide-based solvents such as chloroform and methylene chloride; aromatic hydrocarbon-based solvents such as benzene and toluene; and ether-based solvents such as tetrahydrofuran, 1,3-dioxolane, 1,4-dioxane, dimethyl ether, diethyl ether and p-cresol methyl ether. These solvents are normally used singly, or if necessary, two or more thereof are used in combination as appropriate. From the viewpoint of the solubility and polymerization reactivity of the polyamic acid, DMAc, DMF, NMP and the like may be used.

A polyimide can be obtained by cyclodehydration of the polyamic acid. Examples of the method for preparing a polyimide from a polyamic acid solution include a method in which a dehydrating agent, an imidization catalyst and the like are added to a polyamic acid solution to advance imidization in the solution. The polyamic acid solution may be heated to accelerate the progress of imidization. By mixing a poor solvent with a solution containing a polyimide generated by imidization of the polyamic acid, a polyimide resin is precipitated as a solid. By isolating the polyimide resin as a solid substance, impurities generated during synthesis of the polyamic acid, and the residual dehydration agent and the imidization catalyst and the like can be washed and removed with the poor solvent, so that it is possible to prevent coloring of the polyimide and an increase in yellowness. By isolating the polyimide resin as a solid, a solvent suitable for forming a film, such as a low-boiling-point solvent, can be applied in preparation of a solution for producing a film.

The molecular weight (weight average molecular weight in terms of polyethylene oxide which is measured by gel filtration chromatography (GPC)) of the polyimide may be 10,000 to 300,000, 20,000 to 250,000, or 40,000 to 200,000. An excessively small molecular weight may result in insufficient strength of the film. An excessively large molecular weight may result in poor compatibility with the acryl-based resin.

The polyimide may be soluble in a non-amide-based solvents such as ketone-based solvents and halogenated alkyl-based solvents. The phrase “the polyimide exhibits solubility in a solvent” means that the polyimide is dissolved at a concentration of 5 wt % or more. In one or more embodiments, the polyimide has solubility in methylene chloride. Methylene chloride has a low boiling point, so that it is easy to remove the residual solvent during production of a film. Therefore, the use of a polyimide resin soluble in methylene chloride can be expected to improve productivity of the film.

From the viewpoint of the heat stability and light stability of the resin composition and the film, the polyimide may have low reactivity. The acid value of the polyimide may be 0.4 mmol/g or less, 0.3 mmol/g or less, or 0.2 mmol/g or less. The acid value of the polyimide may be 0.1 mmol/g or less, 0.05 mmol/g or less, or 0.03 mmol/g or less. From the viewpoint of reducing the acid value, the polyimide may have a high imidization ratio. A small acid value tends to lead to enhancement of the stability of the polyimide, and improvement of compatibility with the acryl-based resin.

### Acryl-Based Resin

Examples of the acryl-based resin include poly(meth) acrylic acid esters such as polymethyl methacrylate, methyl methacrylate-(meth)acrylic acid copolymers, methyl methacrylate-(meth) acrylic acid ester copolymers, methyl methacrylate-acrylic acid ester-(meth)acrylic acid copolymers, and methyl (meth)acrylate-styrene copolymers. The acryl-based resin may have a glutarimide structural unit or a lactone ring structural unit introduced by modification. The tacticity of the polymer is not particularly limited, and may be any of an isotactic type, a syndiotactic type and an atactic type.

From the viewpoint of transparency, compatibility with polyimide, and mechanical strength of a formed article such as a film, the acryl-based resin may have methyl methacrylate as a main structural unit. The amount of methyl methacrylate based on the amount of all monomer components in the acryl-based resin may be 60 wt % or more, 70 wt % or more, 80 wt % or more, 85 wt % or more, 90 wt % or more, or 95 wt % or more. The acryl-based resin may be a homopolymer of methyl methacrylate.

In the acryl-based resin, a glutarimide structural unit or a lactone ring structural unit may be introduced as described above. Such a modified polymer may be one obtained by introducing a glutarimide structure or a lactone ring structure into an acrylic polymer whose methyl methacrylate content is in the above-described range. That is, in the acryl-based resin modified by introduction of a glutarimide structure or a lactone ring structure, the total amount of methyl methacrylate and modified structures of methyl methacrylate may be 60 wt % or more, 70 wt % or more, 80 wt % or more, 85 wt % or more, 90 wt % or more, or 95 wt % or more. The modified polymer may be one obtained by introducing a glutarimide structure or a lactone ring structure into a homopolymer of methyl methacrylate.

Introduction of a glutarimide structure or a lactone ring structure into an acryl-based polymer such as methyl methacrylate tends to lead to improvement of the glass transition temperature of the acryl-based resin. The glutarimide-modified acryl-based resin contains an imide structure, and therefore may have improved compatibility with the polyimide.

The acryl-based resin having a glutarimide structure is obtained by, for example, heating and melting a polymethyl methacrylate resin and performing treatment with an imidizing agent as described in Japanese Patent Laid-open Publication No. 2010-261025. When the acryl-based polymer has a glutarimide structure, the glutarimide content may be 3 wt % or more, 5 wt % or more, 10 wt % or more, 20 wt % or more, 30 wt % or more, or 50 wt % or more.

The glutarimide content is calculated by determining the ratio of introduction of the glutarimide structure (imidization ratio) from a ¹H-NMR spectrum of the acryl-based resin and converting the imidization ratio to a weight basis. For example, in methyl methacrylate into which a glutarimide structure has been introduced, the imidization ratio Im=B/(A+B) is determined, where A is an area of a peak originating from O—CH₃ protons of methyl methacrylate (around 3.5 to 3.8 ppm) and B is an area of a peak originating from N—CH₃ protons of glutarimide (around 3.0 to 3.3 ppm).

From the viewpoint of the heat resistance of the film, the glass transition temperature of the acryl-based resin may be 100° C. or higher, 110° C. or higher, 115° C. or higher, or 120° C. or higher.

From the viewpoint of solubility in an organic solvent, compatibility with the polyimide and film strength, the weight average molecular weight of the acryl-based resin (in terms of polystyrene) may be 5,000 to 500,000, 10,000 to 300,000, or 15,000 to 200,000.

From the viewpoint of the heat stability and light stability of the resin composition and the film, the content of reactive functional groups such as ethylenically unsaturated groups and carboxy groups in the acryl-based resin may be small. The iodine value of the acryl-based resin may be 10.16 g/100 g (0.4 mmol/g) or less, 7.62 g/100 g (0.3 mmol/g) or less, or 5.08 g/100 g (0.2 mmol/g) or less. The iodine value of the acryl-based resin may be 2.54 g/100 g (0.1 mmol/g) or less, or 1.27 g/100 g (0.05 mmol/g) or less. The acid value of the acryl-based resin may be 0.4 mmol/g or less, 0.3 mmol/g or less, or 0.2 mmol/g or less. The acid value of the acryl-based resin may be 0.1 mmol/g or less, 0.05 mmol/g or less, or 0.03 mmol/g or less. A small acid value tends to lead to enhancement of the stability of the acryl-based resin, and improvement of compatibility with the polyimide.

### Preparation of Resin Composition

The polyimide resin and the acryl-based resin are blended to prepare a resin composition. Since the polyimide resin and the acryl-based resin at an arbitrary ratio can be compatible with each other, the ratio between the polyimide resin and the acryl-based resin in the resin composition is not particularly limited. The blending ratio (weight ratio) of the polyimide resin to the acryl-based resin may be 9:2 to 2:98, 95:5 to 10:90, or 90:10 to 15:85. When the ratio of the polyimide resin is high, the elastic modulus and the pencil hardness of the film tends to increase, resulting in excellent mechanical strength. When the ratio of the acryl-based resin is high, coloring of the film tends to be suppressed, resulting in enhancement of transparency. For sufficiently exhibiting the effect of improving transparency by blending the polyimide and the acryl-based resin, the ratio of the amount of the acryl-based resin to the total amount of the polyimide and the acryl-based resin may be 10 wt % or more, 15 wt % or more, 20 wt % or more, 25 wt % or more, 30 wt % or more, 35 wt % or more, 40 wt % or more, 45 wt % or more, or 50 wt % or more.

The polyimide is a polymer having a special molecular structure, and generally has low solubility in an organic solvent and is not compatible with other polymers. In one or more embodiments, the polyimide exhibits high solubility in an organic solvent, compatibility with the acryl-based resin, and excellent mechanical strength because the polyimide contains alicyclic tetracarboxylic dianhydride as an acid anhydride component.

A resin composition containing the polyimide and the acryl-based resin may have a single glass transition temperature in differential scanning calorimetry (DSC) and/or dynamic mechanical analysis (DMA). When the resin composition has a single glass transition temperature, it can be considered that the polyimide and the acryl-based resin are completely compatible with each other. A film containing the polyimide and the acryl-based resin may have a single glass transition temperature.

The resin composition may be a mixed solution containing a polyimide resin and an acryl-based resin. The method for blending the resins is not particularly limited, and the resins may be mixed in a solid state, or may be mixed in a liquid to form a mixed solution. The polyimide resin solution and the acryl-based resin solution may be individually prepared, and mixed to prepare a mixed solution of the polyimide resin and the acryl-based resin.

The solvent of a solution containing the polyimide resin and the acryl-based resin is not particularly limited as long as it exhibits an ability to dissolve both the polyimide resin and the ester-based resin. Examples of the solvent include amide-based solvents such as N,N-dimethylformamide, N,N-dimethylacetamide and N-methyl-2-pyrrolidone; ether-based solvents such as tetrahydrofuran and 1,4-dioxane; ketone-based solvents such as acetone, methyl ethyl ketone, methyl propyl ketone, methyl isopropyl ketone, methyl isobutyl ketone, diethyl ketone, cyclopentanone, cyclohexanone and methyl cyclohexanone; and halogenated alkyl solvents such as chloroform, 1,2-dichloroethane, 1,1,2,2-tetrachloroethane, chlorobenzene, dichlorobenzene and methylene chloride.

From the viewpoint of the solubility of the polyimide resin and the compatibility between the polyimide resin and the acryl-based resin in the solution, amide-based solvents are preferable. On the other hand, low-boiling-point non-amide-based solvents are preferable from the viewpoint of solvent removability in production of a formed article such as a film, and ketone-based solvents and halogenated alkyl-based solvents are preferable because they are excellent in ability to dissolve a polyimide resin as well as an acryl-based resin, and have a low boiling point, so that it is easy to remove the residual solvent during production of a film. In the resin composition, compatibility between the polyimide resin and the acryl-based resin is high, so that the compatibility can be exhibited even in a low-boiling-point non-amide-based solvent such as a ketone-based solvent or an alkyl halide-based solvent.

For the purpose of, for example, improving the processability of the film and imparting various functions, an organic or inorganic low-molecular-weight compound, a high-molecular-weight compound (for example, epoxy resin) or the like may be blended in the resin composition (solution). The resin composition may contain a flame retardant, an ultraviolet absorber, a crosslinking agent, a dye, a pigment, a surfactant, a leveling agent, a plasticizer, fine particles, a sensitizer and the like. The fine particles include organic fine particles such as those of polystyrene and polytetrafluoroethylene, and inorganic fine particles such as those of colloidal silica, carbon and layered silicate, and may have a porous or hollow structure. Fiber reinforcement materials include carbon fibers, glass fibers, and aramid fibers.

### Formed Article and Film

The above-described composition can be used for forming various formed articles. Examples of the molding method include melting methods such as injection molding, transfer molding, press molding, blow molding, inflation molding, calender molding, and melt extrusion molding. A resin composition containing a polyimide and an acryl-based resin tends to have a melt viscosity lower than that of a polyimide alone, and is excellent in moldability in injection molding, transfer molding, press molding, melt extrusion molding and the like.

A solution of a resin composition containing a polyimide and an acryl-based resin tends to have a solution viscosity lower than that of a solution of a polyimide alone, which has the same solid concentration. Therefore, the solution is excellent in handling properties such as transportability, and has a high coating property, which is advantageous in suppression of unevenness in thickness of the film, and the like.

In one or more embodiments, the formed article is a film. The method for forming the film may be either a melting method or a solution method, or may be a solution method from the viewpoint of producing a film excellent in transparency and uniformity. In the solution method, a solution containing the polyimide resin and the acryl-based resin is applied onto a support, and the solvent is removed by drying to obtain a film.

As a method for applying the resin solution onto the support, a known method using a bar coater, a comma coater or the like can be applied. As the support, a glass substrate, a metal substrate, a metal drum or a metal belt made of SUS or the like, a plastic film, or the like can be used. From the viewpoint of improving productivity, it is preferable to produce a film by a roll-to-roll process using an endless support such as a metal drum or a metal belt, a long plastic film or the like as a support. When a plastic film is used as the support, a material that is not soluble in a deposition dope solvent may be appropriately selected.

It is preferable to perform heating the solvent during drying. The heating temperature is not particularly limited as long as the solvent can be removed and coloring of the resulting film can be suppressed, and the temperature is appropriately set to room temperature to about 250° C., and may be 50° C. to 220° C. The heating temperature may be elevated stepwise. After drying proceeds to some extent, the resin film may be peeled off from the support and dried for enhancing the solvent removal efficiency. For accelerating the removal of the solvent, heating may be performed under reduced pressure.

Although an acrylic film may have low toughness, strength of the film may be improved by employing a system in which a polyimide and an acryl-based resin are compatible with each other.

The thickness of the film is not particularly limited, and may be appropriately set according to a use purpose. The thickness of the film is, for example, 5 to 300 μm. From the viewpoint of achieving both self-supporting properties and flexibility and obtaining a film having high transparency, the thickness of the film may be 20 μm to 100 μm, 30 μm to 90 μm, 40 μm to 85 μm, or 50 μm to 80 μm. The thickness of the film which is used as a cover film for a display may be 50 μm or more.

The haze of the film may be 10% or less, 5% or less, 4% or less, 3.5% or less, 3% or less, 2% or less, or 1% or less. The haze of the film may be as low as possible. Since the polyimide resin and the acryl-based resin are compatible with each other, a film having a low haze and high transparency is obtained. The resin composition of blending the polyimide and the acryl-based resin may have a haze of 10% or less in production of a film having a thickness of 50 μm.

The yellowness index (YI) of the film may be 2.0 or less, 1.5 or less, or 1.0 or less. As described above, by blending the polyimide resin and the acryl-based resin, a film is obtained which is less colored and has smaller YI as compared to a case where the polyimide resin is used alone.

From the viewpoint of strength, the tensile elastic modulus of the film may be 3.3 Gpa or more, 3.5 Gpa or more, or 4.0 Gpa or more. The pencil hardness of the film may be equal to or greater than F, equal to or greater than H, or equal to or greater than 2H. For the system in which the polyimide and the acryl-based resin are compatible with each other, the pencil hardness hardly decreases even if the ratio of the acryl-based resin is increased. Therefore, it is possible to provide a film which is less colored and excellent in transparency while the excellent mechanical strength characteristic of a polyimide is not significantly reduced.

A film formed from a resin composition containing a polyimide and an acryl-based resin is suitably used as a display material because the film is less colored and has high transparency. In particular, a film having high mechanical strength is applicable to surface members of cover windows of displays, etc. In practical use, a surface of the film of one or more embodiments of the present invention may be provided with an antistatic layer, an easily bondable layer, a hard coat layer, an antireflection layer and the like.

### EXAMPLES

Hereinafter, one or more embodiments of the present invention will be described in further detail by showing examples. One or more embodiments of the present invention are not limited to examples below.

### Polyimide Resin Production Examples

Dimethylformamide was added into a separable flask, and stirred in a nitrogen atmosphere. To this was added a diamine and an acid dianhydride at a ratio (%) as shown in Tables 1 and 2, and the mixture was reacted by stirring in a nitrogen atmosphere for 5 to 10 hours to obtain a polyamic acid solution having a solid content concentration of 18 wt %.

To 100 g of the polyamic acid solution, 5.5 g of pyridine as an imidization catalyst was added, and completely dispersed, 8 g of acetic anhydride was then added, and the mixture was stirred at 90° C. for 3 hours. The solution was cooled to room temperature, and 100 g of 2-propyl alcohol (hereinafter, referred to as “IPA”) was then added dropwise at a rate of 2 to 3 drops/sec while the solution was stirred, thereby precipitating a polyimide. Further, 150 g of IPA was added, the mixture was stirred for about 30 minutes, and suction filtration was performed with a Kiriyama funnel. The obtained solid was washed with IPA, and then dried in a vacuum oven set at 120° C. for 12 hours to obtain a polyimide resin.

### Film Production Examples

### Examples 1 to 10 and 22 to 24 and Comparative Example 1

The polyimide (PI) obtained in the production example and a commercially available polymethyl methacrylate resin (“PARAPET HM1000” manufactured by KURARAY CO., LTD., glass transition temperature: 120° C., acid value: 0.0 mmol/g, hereinafter referred to as “acrylic resin 1”) were mixed in methylene chloride at a ratio as shown in Tables 1 and 2, thereby preparing a methylene chloride solution having a resin content of 11 wt %. This solution was applied onto an alkali-free glass plate, and dried by heating at 60° C. for 15 minutes, 90° C. for 15 minutes, 120° C. for 15 minutes, 150° C. for 15 minutes, 180° C. for 15 minutes, and 200° C. for 15 minutes in an air atmosphere to produce films having a thickness of about 50 μm.

### Examples 11 to 18

Films were prepared under the same conditions as described above except that the following acryl-based resins 2 to 8 (all of which are acryl-based copolymers containing methyl methacrylate as a main monomer component, or modified products thereof) were used instead of the acrylic resin 1.

Acrylic resin 2: “PARAPET HR-G” manufactured by KURARAY CO., LTD., glass transition temperature: 116° C., acid value: 0.0 mmol/g

Acrylic resin 3: Copolymer of methyl methacrylate/methyl acrylate (monomer ratio: 81/19) (“PARAPET GF” manufactured by KURARAY CO., LTD.), glass transition temperature: 102° C., acid value: 0.0 mmol/g

Acrylic resin 4: Copolymer of methyl methacrylate/methyl acrylate (monomer ratio: 87/13) (“PARAPET G” manufactured by KURARAY CO., LTD.), glass transition temperature: 109° C., acid value: 0.0 mmol/g

Acrylic resin 5: Copolymer of methyl methacrylate/methyl acrylate (monomer ratio: 96/4) (“PARAPET EH” manufactured by KURARAY CO., LTD.), glass transition temperature: 116° C., acid value: 0.0 mmol/g

Acrylic resin 6: Syndiotactic polymethyl methacrylate (“PARAPET SP-01” manufactured by KURARAY CO., LTD.), glass transition temperature: 130° C., acid value: 0.0 mmol/g

Acrylic resin 7: Acrylic resin having a glutarimide ring and prepared as described in “Acryl-Based Resin Production Example” in Japanese Patent Laid-open Publication No. 2018-70710 (glutarimide content: 4 wt %, glass transition temperature: 125° C., acid value: 0.4 mmol/g

Acrylic resin 8: Acrylic resin having a glutarimide ring and prepared as described in “Acryl-Based Resin Production Example” in Japanese Patent Laid-open Publication No. 2018-70710 (glutarimide content: 70 wt %, glass transition temperature: 146° C., acid value: 0.1 mmol/g

### Examples 19 to 21 and Comparative Examples 2 to 7

Films were prepared under the same conditions as described above except that instead of methylene chloride (DCM), methyl ethyl ketone (MEK), N,N-dimethylformamide (DMF) or N,N-dimethylacetamide (DMAc) was used as the solvent instead as shown in Tables 1 and 2.

### Reference Examples 1 to 4

In Reference Examples 1 and 3, a methylene chloride solution of a polyimide resin was prepared, and a film having a thickness of about 50 μm was produced under the same conditions as described above. In Reference Examples 2 and 4, films having a thickness of about 50 μm were produced under the same conditions as described above except that methylene chloride solutions of the acrylic resins 1 and 7 were prepared, and the heating conditions during drying were changed to 60° ° C. for 30 minutes, 80° C. for 30 minutes, 100° C. for 30 minutes and 110° C. for 30 minutes.

### Evaluation

### Haze and Total Light Transmittance

The film was cut to a 3 cm square, and the haze and the total light transmittance (TT) were measured in accordance with JIS K 7136 and JIS K 7361-1 using a haze meter “HZ-V3” manufactured by Suga Test Instruments Co., Ltd. For those having a haze of more than 20%, measurements of the yellowness, the tensile elastic modulus and the pencil hardness below were not made.

### Yellowness

The film was cut to a 3 cm square, and the yellowness index (YI) was measured in accordance with JIS K 7373 using a spectrophotometer “SC-P” manufactured by Suga Test Instruments Co., Ltd.

### Tensile Elastic Modulus

A film was cut into a strip shape having a width of 10 mm, and placed still at 23° C./55% RH for 1 day to perform humidity conditioning, and the tensile elastic modulus was measured under the following conditions using “AUTOGRAPH AGS-X” manufactured by Shimadzu Corporation.
Distance between grippers: 100 mm
Tension rate: 20.0 mm/min
Measurement temperature: 23° C.

### Pencil Hardness

The pencil hardness of the film was measured by JIS K 5600-5-4 “Pencil scratch test”.

### Bending Resistance

The film was cut into a strip shape of 20 mm×100 mm, and bent to 180° at the center in the length direction. A film which was not broken was rated “good”, and a film which was broken was rated “poor”.

### Observation with Transmission Electron Microscope (TEM)

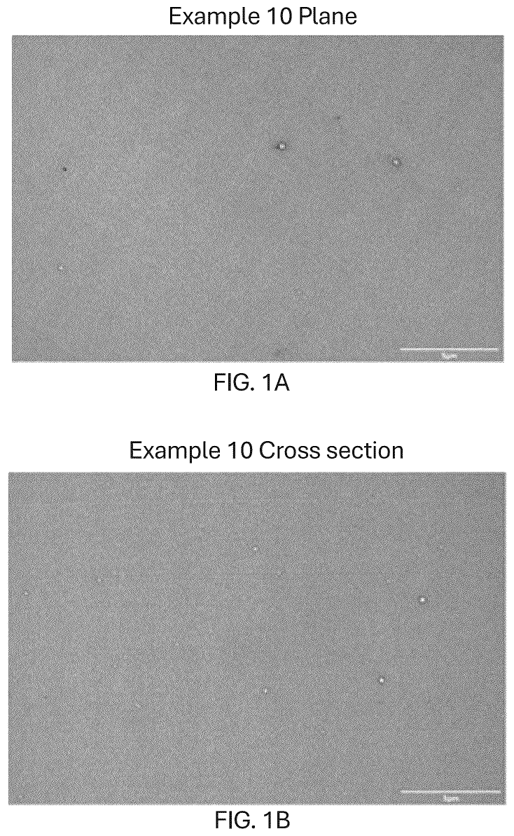

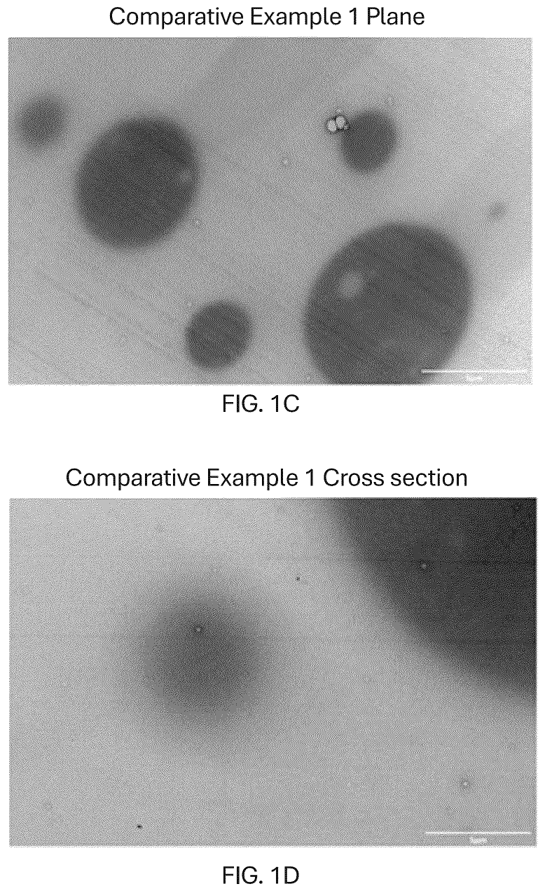

The planes (film surfaces) and cross-sections of the films of Example 10 and Comparative Example 1 were observed with a transmission electron microscope (magnification: 10,000 times). A TEM image is shown in FIGS. 1A-1D.

### Evaluation Results

Tables 1 and 2 show the compositions of resins (compositions of polyimides, types of acryl-based resins and blending ratios) and the results of evaluation of films.

In Tables 1 and 2, the compounds are represented by the following abbreviations.

### Acid Dianhydride

CBDA: 1,2,3,4-Cyclobutanetetracarboxylic dianhydride
H-PMDA: 1,2,4,5-Cyclohexanetracarboxylic dianhydride
H-BPDA: 1,1′-Bicyclohexane-3,3′,4,4′ tetracarboxylic-3,4:3′,4′-dianhydride
TAHMBP: Bis(1,3-dioxo-1,3-dihydroisobenzofuran-5-carboxylic acid)-2,2′,3,3′,5,5′-hexamethylbiphenyl-4,4′-diyl
6FDA: 2,2-Bis(3,4-dicarboxyphenyl)-1,1,1,3,3,3-hexafluoropropanoic dianhydride
BPDA: 3,3′,4,4′-Biphenyltetracarboxylic dianhydride
ODPA: 4,4′-Oxydiphthalic anhydride
PMDA: Pyromellitic dianhydride
BPADA: 4,4′-(4,4′-Isopropylidenediphenoxy)diphthalic anhydride

### Diamine

TFMB: 2,2′-Bis(trifluoromethyl)benzidine
DDS: 3,3′-Diaminodiphenylsulfone
DAT: 2,4-Diaminotoluene
ODA: 4,4′-Diaminodiphenyl ether
m-Tol: 2,2′-Dimethylbenzidine

TABLE 1

| | Composition of Resin | | | | | | | | | |
|---|---|---|---|---|---|---|---|---|---|---|
| | Composition of Polyimide (mol %) | | | | | | | | | |
| | Acid dianhydride | | | | | | Diamine | | | |
| | Alicyclic | | | | Others | | | Others | | Acrylic |
| | kind | amount | TAHMBP | 6FDA | kind | amount | TFMB | kind | amount | Resin |
| Example 1 | CBDA | 30 | 50 | — | ODPA | 20 | 90 | DDS | 10 | 1 |
| Reference | CBDA | 30 | 50 | — | ODPA | 20 | 90 | DDS | 10 | — |
| Example 1 | | | | | | | | | | |
| Reference | — | | | | | | | | | 1 |
| Example 2 | | | | | | | | | | |
| Example 2 | CBDA | 37.5 | 62.5 | — | — | | 100 | — | | 1 |
| Example 3 | CBDA | 25 | 50 | — | BPDA | 25 | 100 | — | | 1 |
| Example 4 | CBDA | 20 | 60 | 20 | — | | 100 | — | | 1 |
| Example 5 | CBDA | 20 | 40 | 20 | BPDA | 20 | 90 | DDS | 10 | 1 |

| | | | | | | | | | |
|---|---|---|---|---|---|---|---|---|---|
| Example 6 | CBDA | 30 | 50 | 20 | — | 90 | DDS | 10 | 1 |

| Example 7 | CBDA | 15 | — | 85 | — | | 100 | — | 1 |
|---|---|---|---|---|---|---|---|---|---|
| Reference | CBDA | 15 | — | 85 | — | | 100 | — | — |
| Example 3 | | | | | | | | | |
| Example 8 | CBDA | 20 | — | 70 | PMDA | 10 | 100 | — | 1 |

| Example 9 | CBDA | 30 | — | 70 | — | 100 | — | 1 |
|---|---|---|---|---|---|---|---|---|
| Example 10 | CBDA | 30 | — | 70 | — | 100 | — | 1 |
| Example 11 | CBDA | 30 | — | 70 | — | 100 | — | 1 |
| Example 12 | CBDA | 30 | — | 70 | — | 100 | — | 2 |
| Example 13 | CBDA | 30 | — | 70 | — | 100 | — | 3 |
| Example 14 | CBDA | 30 | — | 70 | — | 100 | — | 4 |
| Example 15 | CBDA | 30 | — | 70 | — | 100 | — | 5 |
| Example 16 | CBDA | 30 | — | 70 | — | 100 | — | 6 |
| Example 17 | CBDA | 30 | — | 70 | — | 100 | — | 7 |
| Reference | — | | | | | | | 7 |
| Example 4 | | | | | | | | |
| Example 18 | CBDA | 30 | — | 70 | — | 100 | — | 8 |

| | | | Film Properties | | | | | | |
|---|---|---|---|---|---|---|---|---|---|
| | Composition of Resin | | | | | | Tensile | | |
| | PI/Acryl | | Thick- | | | | Elastic | Pencil | Bending |
| | (weight | | ness | Haze | TT | | Modulus | Hard- | Resis- |
| | ratio) | Solvent | (μm) | (%) | (%) | YI | (Gpa) | ness | tance |
| Example 1 | 50/50 | DCM | 60 | 1.4 | 90.8 | 1.1 | 4.6 | 2H | good |
| Reference | 100/0 | DCM | 50 | 0.3 | 89.2 | 2.4 | 5.6 | 3H | good |
| Example 1 | | | | | | | | | |
| Reference | 0/100 | DCM | 60 | 0.3 | 92.5 | 0.2 | 2.6 | HB | poor |
| Example 2 | | | | | | | | | |
| Example 2 | 50/50 | DCM | 54 | 0.2 | 91.1 | 0.8 | 4.8 | F | good |
| Example 3 | 50/50 | DCM | 58 | 2.1 | 90.8 | 1.3 | 4.6 | 3H | good |
| Example 4 | 50/50 | DCM | 57 | 0.3 | 91.0 | 0.8 | 4.3 | 2H | good |
| Example 5 | 50/50 | DCM | 56 | 1.2 | 90.4 | 0.9 | 4.2 | H | good |
| Example 6 | 50/50 | DCM | 56 | 0.9 | 91.1 | 0.4 | 4.5 | 2H | good |
| Example 7 | 30/70 | DCM | 53 | 0.3 | 91.7 | 0.6 | 3.6 | F | good |
| Reference | 100/0 | DCM | 50 | 0.2 | 90.7 | 1.1 | 3.7 | H | good |
| Example 3 | | | | | | | | | |
| Example 8 | 50/50 | DCM | 51 | 0.2 | 91.7 | 0.9 | 3.7 | 3H | good |
| Example 9 | 30/70 | DCM | 56 | 0.2 | 92.1 | 0.4 | 3.4 | H | good |
| Example 10 | 50/50 | DCM | 58 | 0.3 | 91.7 | 0.5 | 3.9 | 2H | good |
| Example 11 | 70/30 | DCM | 48 | 0.2 | 91.2 | 0.7 | 4.2 | 2H | good |
| Example 12 | 50/50 | DOM | 60 | 0.3 | 91.7 | 0.6 | 4.0 | 2H | good |
| Example 13 | 50/50 | DCM | 56 | 0.5 | 91.6 | 0.7 | 4.1 | 3H | good |
| Example 14 | 50/50 | DCM | 59 | 0.3 | 91.6 | 0.6 | 4.0 | H | good |
| Example 15 | 50/50 | DCM | 59 | 0.3 | 91.6 | 0.5 | 3.9 | 3H | good |
| Example 16 | 50/50 | DCM | 63 | 0.4 | 91.6 | 0.6 | 3.9 | 3H | good |
| Example 17 | 50/50 | DCM | 64 | 0.3 | 91.5 | 0.6 | 4.0 | 3H | good |
| Reference | 0/100 | DCM | 51 | 0.2 | 92.5 | 0.2 | 2.6 | B | poor |
| Example 4 | | | | | | | | | |
| Example 18 | 55/45 | DCM | 52 | 0.3 | 91.3 | 0.7 | 4.0 | 3H | good |

TABLE 2

| | Composition of Resin | | | | | | | | | |
|---|---|---|---|---|---|---|---|---|---|---|
| | Composition of Polyimide (mol %) | | | | | | | | | |
| | Acid dianhydride | | | | | | Diamine | | | |
| | Alicyclic | | | | Others | | | Others | | Acrylic |
| | kind | amount | TAHMBP | 6FDA | kind | amount | TFMB | kind | amount | Resin |
| Example 19 | CBDA | 30 | — | 50 | BPDA | 10 | 90 | DDS | 10 | 1 |
| | | | | | PMDA | 10 | | | | |

| | | | | | | | | | |
|---|---|---|---|---|---|---|---|---|---|
| Example 20 | CBDA | 30 | — | 70 | — | 50 | m-Tol | 50 | 1 |
| Example 21 | CBDA | 60 | — | 40 | — | 70 | DDS | 30 | 1 |

| | | | | | | | | |
|---|---|---|---|---|---|---|---|---|
| Example 22 | H-PMDA | 10 | — | 90 | — | 100 | — | 1 |
| Example 23 | H-PMDA | 30 | — | 70 | — | 100 | — | 1 |
| Example 24 | H-BPDA | 30 | — | 70 | — | 100 | — | 1 |

| Comparative | — | — | 100 | — | | 100 | — | 1 |
|---|---|---|---|---|---|---|---|---|
| Example 1 | | | | | | | | |
| Comparative | — | — | 100 | — | | 100 | — | 1 |
| Example 2 | | | | | | | | |
| Comparative | — | — | — | BPADA | 100 | 100 | — | 1 |
| Example 3 | | | | | | | | |

| | | | | | | | | | |
|---|---|---|---|---|---|---|---|---|---|
| Comparative | CBDA | 30 | — | 70 | — | — | DDS | 100 | 1 |
| Example 4 | | | | | | | | | |
| Comparative | CBDA | 30 | — | 70 | — | — | DAT | 100 | 1 |
| Example 5 | | | | | | | | | |
| Comparative | H-PMDA | 100 | — | — | — | — | ODA | 100 | 1 |
| Example 6 | | | | | | | | | |

| | | | | | | | | |
|---|---|---|---|---|---|---|---|---|
| Comparative | H-PMDA | 100 | — | — | — | 100 | — | 1 |
| Example 7 | | | | | | | | |

| | | | Film Properties | | | | | | |
|---|---|---|---|---|---|---|---|---|---|
| | Composition of Resin | | | | | | Tensile | | |
| | PI/Acryl | | Thick- | | | | Elastic | Pencil | Bending |
| | (weight | | ness | Haze | TT | | Modulus | Hard- | Resis- |
| | ratio) | Solvent | (μm) | (%) | (%) | YI | (Gpa) | ness | tance |
| Example 19 | 50/50 | DMF | 55 | 0.2 | 91.5 | 1.1 | 3.5 | 2H | good |
| Example 20 | 50/50 | DMF | 50 | 0.2 | 91.4 | 1.4 | 3.5 | 3H | good |
| Example 21 | 50/50 | MEK | 48 | 0.3 | 91.6 | 0.6 | 3.8 | H | good |
| Example 22 | 50/50 | DCM | 78 | 0.6 | 91.3 | 0.6 | 3.3 | 2H | good |
| Example 23 | 50/50 | DCM | 51 | 0.3 | 91.7 | 0.6 | 3.3 | 2H | good |
| Example 24 | 50/50 | DCM | 67 | 0.2 | 91.8 | 0.6 | 3.3 | 2H | good |
| Comparative | 50/50 | DCM | 51 | 56 | | | | | poor |
| Example 1 | | | | | | | | | |
| Comparative | 50/50 | DMF | 52 | 0.3 | 91.7 | 0.7 | 3.3 | H | good |
| Example 2 | | | | | | | | | |
| Comparative | 50/50 | DMF | 59 | 0.2 | 91.0 | 0.9 | 3.0 | F | good |
| Example 3 | | | | | | | | | |
| Comparative | 50/50 | DMAc | 53 | 93 | | | | | poor |
| Example 4 | | | | | | | | | |
| Comparative | 50/50 | DMAc | 63 | 93 | | | | | poor |
| Example 5 | | | | | | | | | |
| Comparative | 50/50 | DMAc | 40 | 70 | | | | | poor |
| Example 6 | | | | | | | | | |
| Comparative | 50/50 | DMF | 55 | 81 | | | | | poor |
| Example 7 | | | | | | | | | |

The polyimide film of Reference Example 1 which was produced using only the polyimide resin had a YI of more than 2, and did not have sufficient transparency. In contrast, the acrylic film of Reference Example 2 which was produced using only the acrylic resin 1 had a low tensile elastic modulus and a pencil hardness of HB, and did not have sufficient mechanical strength. In addition, the acrylic film of Reference Example 2 did not have sufficient bending resistance. The acrylic film of Reference Example 4 had a low tensile elastic modulus and pencil hardness, and did not have sufficient bending resistance as in Reference Example 2.

In Example 1 using a resin composition of blending a polyimide resin identical to that in Reference Example 1 and the acrylic resin 1, YI was smaller and the total light transmittance was higher as compared to Reference Example 1. In Examples 2 to 11 using polyimide resins different from the polyimide resin in Example 1, an increase in haze of the film was suppressed, YI was small, and the excellent mechanical strength was exhibited as in Example 1. Like comparison between Reference Example 1 and Example 1, comparison between Reference Example 3 and Example 7 showed that by blending the polyimide resin and the acryl-based resin, coloring of the film was suppressed and transparency was improved while the excellent mechanical strength of the polyimide was not significantly reduced. In Examples 12 to 18 using acrylic resins 2 to 8, the film was excellent in transparency and mechanical strength as in Examples 1 to 11.

In Comparative Example 1 where a film was produced using a methylene chloride solution of a resin composition of blending a polyimide resin free of alicyclic tetracarboxylic dianhydride and the acrylic resin 1, the film had a significantly high haze. Like the acrylic film of Reference Example 2, the film of Comparative Example I did not have sufficient bending resistance.

In the film of Example 10, a sea-island structure was not observed in a TEM image, and thus the polyimide resin and the acryl-based resin were completely compatible with each other, whereas in the film of Comparative Example 1, a sea-island structure was confirmed in a TEM image, as shown in FIGS. 1A-1D. It is considered that in Comparative Example 1, the film is poor in transparency and mechanical strength because the compatibility between the polyimide resin and the acryl-based resin in the methylene chloride solution is low.

In Comparative Example 2, where a film was produced using a DMF solution of a mixture of a polyimide resin identical to that in Comparative Example 1 and the acrylic resin, the film had a low haze and high transparency. However, the film of Comparative Example 2 had a lower tensile elastic modulus and pencil hardness, and was inferior in mechanical strength as compared to the films of Examples 1 to 18. The film of Comparative Example 3 was inferior in mechanical strength to the films of Examples as in Comparative Example 2.

From these results, it can be seen that in Examples 1 to 18, a film having high transparency and excellent mechanical strength is obtained because the polyimide contains CBDA having an alicyclic structure as the tetracarboxylic dianhydride component, so that the compatibility between the polyimide and the acryl-based resin is high, and excellent compatibility is exhibited even in a non-amide-based solvent such as methylene chloride.

The films of Examples 19 and 20, each of which was produced using a DMF solution of a resin composition of blending a polyimide resin containing alicyclic tetracarboxylic dianhydride and the acrylic resin 1, were superior in mechanical strength to the films of Comparative Examples 2 and 3. The film of Example 21, which was produced using MEK as the solvent, had a high tensile elastic modulus and excellent mechanical strength.

In Examples 22 and 23 using a polyimide containing H-PMDA as alicyclic tetracarboxylic dianhydride and in Example 24 using a polyimide containing H-BPDA as tetracarboxylic dianhydride having an alicyclic structure, as in Examples 1 to 18, the film produced using a solution in methylene chloride had a low haze, was excellent in transparency, and exhibited high mechanical strength.

The films of Examples 22 to 24 had a smaller tensile elastic modulus as compared to the films of Examples 1 to 18 using a polyimide containing CBDA as the alicyclic tetracarboxylic dianhydride. From these results, it can be seen that a resin composition of blending a polyimide containing CBDA as alicyclic tetracarboxylic dianhydride and an acryl-based resin is excellent in compatibility and particularly excellent in mechanical strength.

In the resin compositions of Comparative Examples 4 to 7, the polyimide resin contained tetracarboxylic dianhydride having an alicyclic structure as tetracarboxylic dianhydride, but the film produced using an amide-based solvent had a high haze, showing poor compatibility between the polyimide resin and the acryl-based resin. It is considered that in Comparative Examples 4 to 6, the compatibility with the acryl-based resin was not sufficient because polyimide did not contain a perfluoroalkyl group-containing diamine as a diamine component. In Comparative Examples 5 and 6, the factor of the low compatibility with the acryl-based resin may be that in the polyimide, all the tetracarboxylic dianhydrides are alicyclic tetracarboxylic dianhydrides, and any other tetracarboxylic dianhydride is not contained.

From the above results, it can be seen that a polyimide containing a specific amount of alicyclic tetracarboxylic dianhydride as a tetracarboxylic dianhydride component and a perfluoroalkyl group-containing diamine such as TFMB as a diamine exhibits compatibility with an acryl-based resin, and by using a resin composition of blending these components, a film having high transparency and excellent mechanical strength is obtained.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A resin composition comprising:
a polyimide; and
an acryl-based resin,
wherein:
the polyimide includes:
an alicyclic tetracarboxylic dianhydride as a tetracarboxylic dianhydride component; and
a diamine having a perfluoroalkyl group as a diamine component, and
an amount of the alicyclic tetracarboxylic dianhydride based on an amount of all tetracarboxylic dianhydride components in the polyimide is 1 to 80 mol %.

2. The resin composition according to claim 1, wherein the alicyclic tetracarboxylic dianhydride is at least one selected from the group consisting of 1,2,3,4-cyclobutanetetracarboxylic dianhydride, 1,2,3,4-cyclopentanetetracarboxylic dianhydride, and 1,2,4,5-cyclohexanetetracarboxylic dianhydride, 1,1′-bicyclohexane-3,3′,4,4′-tetracarboxylic-3,4:3′,4′-dianhydride.

3. The resin composition according to claim 1, wherein the polyimide further includes at least one selected from the group consisting of fluorine-containing aromatic tetracarboxylic dianhydride, bis(trimellitic anhydride) ester and diphthalic anhydride having an ether bond, as the tetracarboxylic dianhydride component, in addition to the alicyclic tetracarboxylic dianhydride.

4. The resin composition according to claim 3, wherein a total content of alicyclic tetracarboxylic dianhydride, fluorine-containing aromatic tetracarboxylic dianhydride, bis(trimellitic anhydride)ester and diphthalic anhydride having an ether bond is 50 mol % or more based on the amount of all tetracarboxylic dianhydride component in the polyimide.

5. The resin composition according to claim 1, wherein the diamine having a perfluoroalkyl group is a perfluoroalkyl-substituted benzidine.

6. The resin composition according to claim 1, wherein the diamine having a perfluoroalkyl group is 2,2′-bis(trifluoromethyl)benzidine.

7. The resin composition according to claim 1, wherein an amount of the diamine having a perfluoroalkyl group is 50 mol % or more based on the amount of all diamine component in the polyimide.

8. The resin composition according to claim 1, wherein a total amount of methyl methacrylate and modified structures of methyl methacrylate is 60 wt % or more based on an amount of all monomer components in the acryl-based resin.

9. The resin composition according to claim 1, wherein the acryl-based resin has a glass transition temperature of 110° C. or higher.

10. The resin composition according to claim 1, containing the polyimide and the acryl-based resin at a weight ratio of 98:2 to 2:98.

11. A formed article comprising the resin composition of claim 1.

12. A film comprising the resin composition of claim 1.

13. The film according to claim 12, having a thickness of 5 μm or more and 300 μm or less, a total light transmittance of 85% or more, a haze of 10% or less, a yellowness index of 2.0 or less, a tensile elastic modulus of 3.3 GPa or more, and a pencil hardness equal to or greater than F.
